(19) United States
(12) Patent Application Publication
(10) Pub. No.: US 2025/0001659 A1
(43) Pub. Date: Jan. 2, 2025

(54) METHOD FOR PRODUCING EXTERIOR COVER FOR STRADDLED VEHICLE, EXTERIOR COVER FOR STRADDLED VEHICLE, AND STRADDLED VEHICLE

(71) Applicant: YAMAHA HATSUDOKI KABUSHIKI KAISHA, Iwata-shi (JP)

(72) Inventors: Naoki OHMURA, Shizuoka (JP); Takeshi OISHI, Shizuoka (JP)

(21) Appl. No.: 18/741,684

(22) Filed: Jun. 12, 2024

(30) Foreign Application Priority Data
Jun. 29, 2023 (JP) 2023-107267

(51) Int. Cl. B29C 45/14; B29C 45/37; B29L 31/30; B32B 3/26; B32B 7/12; B32B 27/08; B62J 17/00

(52) U.S. Cl. CPC B29C 45/14065; B29C 45/37; B32B 3/266; B32B 7/12; B32B 27/08; B29C 2045/14122; B29L 2031/3005; B32B 2250/44; B32B 2255/10; B32B 2255/28; B32B 2307/412; B32B 2605/00; B62J 17/00

(57) ABSTRACT

A method for producing an exterior cover, including a decorative layer provided on a resin substrate layer, for a straddled vehicle. The method comprising: providing a mold having a protrusion on an inner surface thereof; preparing a decorative film and setting the decorative film in the mold; and subsequently injecting a resin material into the mold and performing injection molding. The protrusion in formed in such a shape that, in the step of injecting the resin material into the mold and performing the injection molding, the protrusion causes an attachment portion to be formed on the resin substrate layer, the attachment portion being so shaped as to allow the exterior cover to be attachable to a main body of the straddled vehicle, and the protrusion catches the decorative film when the decorative film moves along with a flow of the resin material.

### CROSS REFERENCE TO RELATED APPLICATIONS

This application is based upon and claims the benefit of priority of the prior Japanese Patent Application No. 2023-107267, filed on Jun. 29, 2023, the entire contents of which are incorporated herein by reference.

### BACKGROUND

### 1. Technical Field

The present invention relates to an exterior cover for a straddled vehicle, a method for producing the same, and a straddled vehicle.

### 2. Description of the Related Art

Resin-molded items are in wide use for various uses including exterior and interior members of vehicles, home appliances, and the like. Conventionally, a surface of such a resin-molded item is decorated by coating or printing in order to improve the design thereof.

Recently, such a resin-molded item is also decorated by film insert molding in order to further improve the design thereof or to improve the productivity thereof. The film insert molding is performed as follows: in a state where a decorative film is set in a mold, a resin material is injected into the mold and injection molding is performed. The resultant resin-molded item has a stack structure including a resin substrate layer and a decorative layer. The decorative film is set on an inner surface of the mold by, for example, electrostatic adsorption. The decorative film usable for the film insert molding is disclosed in, for example, Japanese Laid-Open Patent Publication No. 2010-125645.

Patent Document No. 1: Japanese Laid-Open Patent Publication No. 2010-125645

### SUMMARY

With the film insert molding, the decorative film may undesirably be positionally shifted along with a flow of the resin material during the injection molding. Such a positional shift of the decorative film declines the appearance of the resin-molded item.

An embodiment of the present invention made in light of the above-described problem has an object of providing an exterior cover for a straddled vehicle and a method for producing the same by which the positional shift of the decorative film during the film insertion molding is suppressed.

This specification discloses a method for producing an exterior cover for a straddled vehicle, an exterior cover for a straddled vehicle, and a straddled vehicle described in the following items.

### Item 1

A method for producing an exterior cover for a straddled vehicle, the exterior cover including a resin substrate layer and a decorative layer provided on the resin substrate layer, the method comprising:
step (a) of preparing a decorative film and setting the decorative film in a mold; and
step (b) of, after step (a), injecting a resin material into the mold and performing injection molding to form a stack structure including the resin substrate layer and the decorative layer,
wherein the resin substrate layer includes an attachment portion having a structure to attach the exterior cover to a vehicle main body,
wherein an inner surface of the mold includes a protrusion to form the attachment portion of the resin substrate layer, and
wherein step (a) is performed such that the decorative film is caught by the protrusion of the mold when being caused to move along with a flow of the resin material in step (b).

The method for producing the exterior cover for a straddled vehicle according to an embodiment of the present invention includes step (a) of preparing the decorative film and setting the decorative film in the mold; and step (b) of, after step (a), injecting a resin material into the mold and performing injection molding to form a stack structure including the resin substrate layer and the decorative layer. In the production method according to an embodiment of the present invention, the inner surface of the mold includes the protrusion attachment portion of the resin substrate layer. Step (a) is performed such that the decorative film is caught by the protrusion of the mold when being caused to move along with a flow of the resin material in step (b). Therefore, the positional shift of the decorative film in step (b) is suppressed. This allows the decorative film to be located at a desired position accurately and thus may prevent the appearance of the exterior cover from being declined.

### Item 2

The method of item 1, wherein the decorative film has a shape partially enclosing the protrusion as seen in a plan view in a state of being set in the mold.

In the case where the decorative film has a shape partially enclosing the protrusion as seen in a plan view in a state of being set in the mold, the decorative film may be caught by the protrusion like being hooked, and this suppresses the positional shift of the decorative film.

### Item 3

The method of item 1,
wherein the decorative film includes a hole, and
wherein in step (a), the decorative film is set such that the protrusion is inserted into the hole.

In the case where the decorative film includes the hole and the decorative film is set such that the protrusion is inserted into the hole, an inner circumferential surface of the hole is caught by the protrusion, so that the positional shift of the decorative film is suppressed.

### Item 4

The method of any one of items 1 through 3,
wherein the inner surface of the mold includes a plurality of the protrusions, and
wherein step (a) is performed such that the decorative film is caught by at least two of the plurality of protrusions when being caused to move in step (b).

In the case where the inner surface of the mold includes the plurality of protrusions, it is preferred that step (a) is performed such that the decorative film is caught by at least two of the protrusions when being caused to move in step (b). The decorative film is caught by at least two of the protrusions, so that a rotation of the decorative film is suppressed. Therefore, the positional shift of the decorative film is suppressed more certainly.

### Item 5

The method of any one of items 1 through 4,
wherein in step (a), the decorative film is set in the mold in a state where the decorative film has a protective film bonded to one of main surfaces thereof, and
wherein the method further includes step (c) of, after step (b), peeling off the protective film from the decorative layer.

In step (a), the decorative film may be set in the mold in a state where the decorative film has the protective film bonded to one of the main surfaces thereof. In this case, in step (c) performed after step (b), the protective film is peeled off from the decorative layer.

In the case where there are foreign objects such as dust or the like between the inner surface of the mold and the decorative film, it may be possible that the foreign objects are attached to the decorative layer of the resultant exterior cover and are not removed therefrom, or that the decorative layer is deformed (damaged) by the foreign objects. In such a case, the appearance of the exterior cover may be undesirably declined. Therefore, in order to prevent the appearance of the exterior cover from being declined due to the foreign objects, a work of removing the foreign objects is performed before step (a), for example.

In step (a), the decorative film is set in the mold in a state where the decorative film has the protective film bonded to one of the main surfaces thereof, and then, in step (c), the protective film is peeled off from the decorative layer. With such an arrangement, even if there are foreign objects between the inner surface of the mold and the protective film, the foreign objects are prevented from being attached to the decorative layer because the foreign objects are peeled off, together with the protective film, from the decorative layer. In addition, the protective film acts as a cushion, and therefore, the decorative layer is prevented from being deformed (damaged) by the foreign objects. This may make it unnecessary to perform the work of removing the foreign objects.

When the protective film is peeled off from the decorative layer, a stepped portion corresponding to the thickness of the protective layer is formed between a region, of a surface of the exterior cover, where the decorative layer is present, and a region, of the surface of the exterior cover, where the decorative layer is not present. In the case where the exterior cover is to be in contact with the body of a rider, this stepped portion may improve the slip resistance.

### Item 6

The method of item 5, wherein the method does not include the step of pre-forming the decorative film after step (a) but before step (b).

In the case where the decorative film having the protective film bonded thereto is set in step (a), it is preferred that the step of pre-forming the decorative film is not performed after step (a) but before step (b). The step of pre-forming the decorative film is not performed, so that a situation is prevented where the pressure-sensitive adhesive is hardened and thus it is made difficult to peel off the protective film.

### Item 7

The method of item 5 or 6, wherein the protective film includes a plurality of regions having different thicknesses from each other.

In the case where the protective film includes the plurality of regions having different thicknesses from each other, the surface of the exterior cover is allowed to include a plurality of regions having different depths of the stepped portion. Therefore, the slip resistance of the exterior cover is adjustable on a region-by-region basis.

### Item 8

The method of any one of items 1 through 7, wherein in step (a), a plurality of the decorative films are prepared, and the plurality of decorative films are set in the mold separately from each other.

In step (a), a plurality of the decorative films may be prepared, and the plurality of decorative films may be set in the mold separately from each other. This may realize a structure in which the decorative layer includes a plurality of portions separated from each other.

### Item 9

An exterior cover for a straddled vehicle, comprising:
a resin substrate layer; and
a decorative layer provided on the resin substrate layer,
wherein the resin substrate layer includes a hole, and
wherein the decorative layer has a shape enclosing the hole at least partially as seen in a plan view.

The exterior cover for a straddled vehicle according to an embodiment of the present invention includes the resin substrate layer and the decorative layer provided on the resin substrate layer, and may be produced by film insert molding by use of the decorative film. In the exterior cover for a straddled vehicle according to an embodiment of the present invention, the resin substrate layer includes the hole, and the decorative layer has a shape enclosing the hole at least partially as seen in a plan view. Such a structure suppresses the positional shift of the decorative film during the film insert molding. This allows the decorative film to be located at a desired position accurately and thus may prevent the appearance from being declined.

### Item 10

The exterior cover for a straddled vehicle of item 9, wherein the decorative layer includes a portion partially enclosing the hole as seen in a plan view.

The decorative layer may include a portion partially enclosing the hole of the resin substrate layer as seen in a plan view.

### Item 11

The exterior cover for a straddled vehicle of item 9, wherein the decorative layer includes a portion enclosing the entirety of the hole as seen in a plan view.

The decorative layer may include a portion enclosing the entirety of the hole of the resin substrate layer as seen in a plan view.

### Item 12

The exterior cover for a straddled vehicle of any one of items 9 through 11,
wherein the resin substrate layer includes a plurality of the holes, and
wherein the decorative layer includes a portion enclosing at least two holes among the plurality of holes at least partially as seen in a plan view.

In the case where the resin substrate layer includes the plurality of holes, it is preferred that the decorative layer includes a portion enclosing at least two of the holes at least partially as seen in a plan view. This suppresses a rotation of the decorative film during the film insert molding, and therefore, suppresses the positional shift of the decorative film more certainly.

### Item 13

The exterior cover for a straddled vehicle of any one of items 9 through 12,
wherein the decorative layer is provided on a first region, which is a part of a main surface of the resin substrate layer, and
wherein there is a stepped portion between a surface of the decorative layer and a second region, which is a region of the main surface of the resin substrate layer other than the first region, and the surface of the decorative layer is lower than the second region.

With the structure in which there is a stepped portion between the surface of the decorative layer and the region (second region) of the main surface of the resin substrate layer other than the region (first region) where the decorative layer is provided, in the case where the exterior cover is to be in contact with the body of a rider, this stepped portion may improve the slip resistance.

### Item 14

The exterior cover for a straddled vehicle of item 13, including a plurality of regions having different depths of the stepped portion.

In the case where the exterior cover includes the plurality of regions having different depths of the stepped portion, the slip resistance of the exterior cover is adjustable on a region-by-region basis.

### Item 15

The exterior cover for a straddled vehicle of any of items 9 through 14, wherein the decorative layer includes a plurality of portions separated from each other.

The decorative layer may include the plurality of portions separated from each other.

### Item 16

A straddled vehicle, comprising the exterior cover for a straddled vehicle of any one of items 9 through 15.

An embodiment of the present invention provides an exterior cover for a straddled vehicle and a method for producing the same by which the positional shift of the decorative film during film insertion molding is suppressed.

### BRIEF DESCRIPTION OF THE DRAWINGS

FIG. 1 is a front view schematically showing an exterior cover 100 for a straddled vehicle according to an embodiment of the present invention.

FIG. 2 is a rear view schematically showing the exterior cover 100.

FIG. 3 is a cross-sectional view schematically showing the exterior cover 100, showing a cross-section taken along line 3A-3A′ in FIG. 1.

FIG. 4 is an enlarged view of region Re enclosed by the dotted circle in FIG. 3.

FIG. 5 is a cross-sectional view showing an example of stack structure of a decorative layer 20 included in the exterior cover 100.

FIG. 6 is a flowchart showing an example of method for producing the exterior cover 100.

FIG. 7 is a cross-sectional view showing an example of decorative film 20′ usable to produce the exterior cover 100.

FIG. 8 shows how to set the decorative film 20′ in a mold 1.

FIG. 9 shows a state where a stack structure including a first substrate layer 10 and the decorative layer 20 is formed as a result of a resin material being injected into the mold 1 in a closed state.

FIG. 10 shows how to peel off a protective film 24 from the decorative layer 20 of the exterior cover 100.

FIG. 11 is a plan view showing a state where the decorative film 20′ is set on an inner surface of the mold 1 (molding surface 2a of a fixed mold 2).

FIG. 12 is a cross-sectional view showing a state where the mold 1 is closed after the decorative film 20′ is set, showing a cross-section taken along line 12A-12A′ in FIG. 11.

FIG. 13 is a plan view showing another example of the decorative film 20′.

FIG. 14 shows the exterior cover 100 produced by use of the decorative film 20′ shown in FIG. 13.

FIG. 15 is a cross-sectional view showing an example of the protective film 24 including a plurality of regions having different thicknesses from each other.

FIG. 16 is a cross-sectional view showing an example of the exterior cover 100 including a plurality of regions having different depths of a stepped portion (depths of a recessed portion rp) from each other.

FIG. 17 is a cross-sectional view showing an example of the exterior cover 100 in which there is no stepped portion between a second region R2 of a surface of a first substrate layer 10 and a surface of the decorative layer 20.

FIG. 18 shows a state, in step S1, where two decorative films 20A′ and 20B′ are prepared and are set in the mold 1 separately from each other.

FIG. 19 shows a structure of the decorative layer 20 including the plurality of portions 20A and 20B separated from each other.

FIG. 20 is a side view schematically showing a motorcycle 200 including an exterior cover according to an embodiment of the present invention.

### DETAILED DESCRIPTION

Hereinafter, an embodiment of the present invention will be described with reference to the drawings. The present invention is not limited by the following embodiment.

### Structure of the Exterior Cover

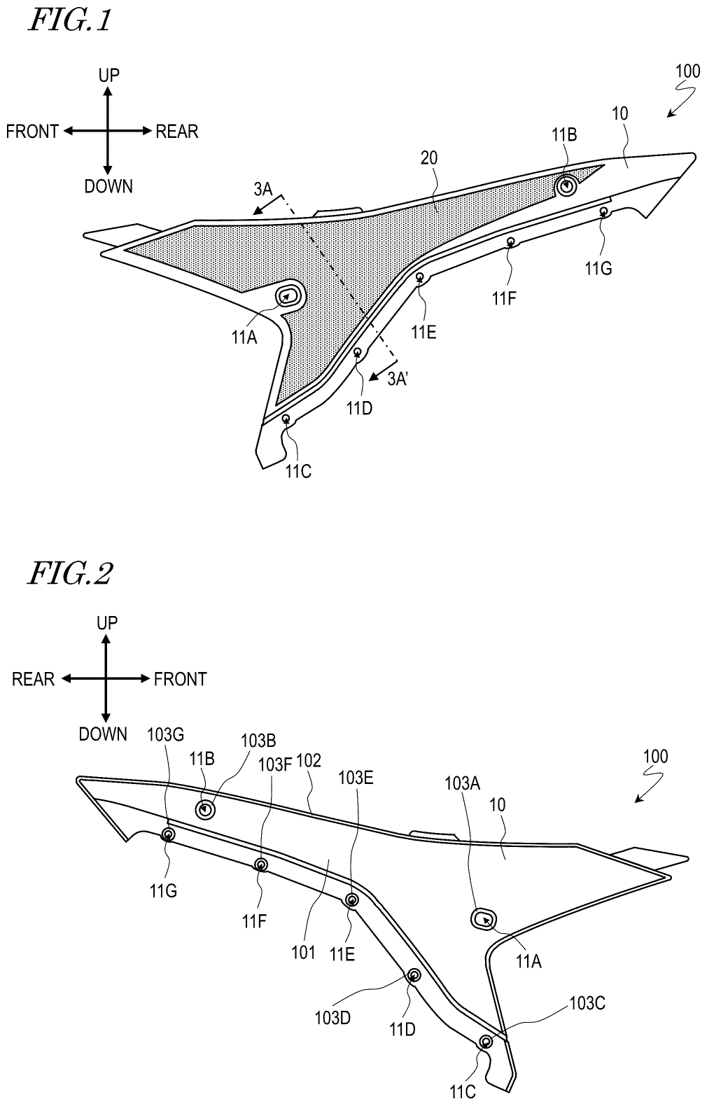

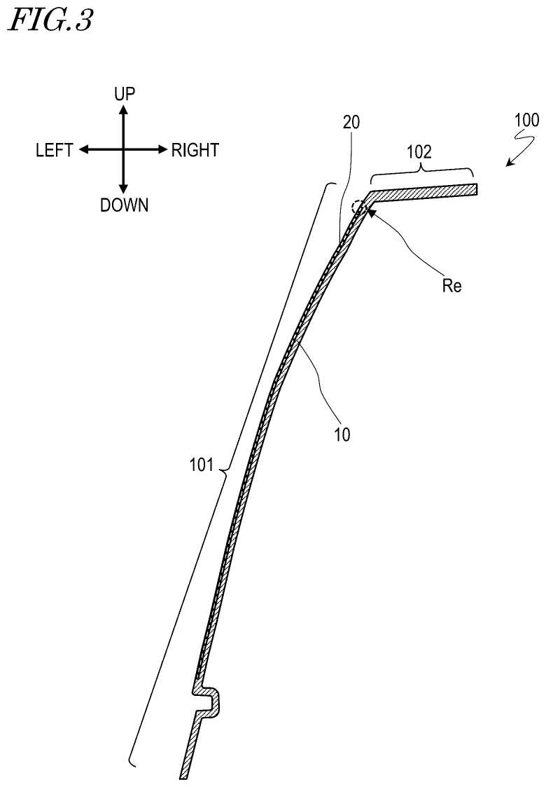

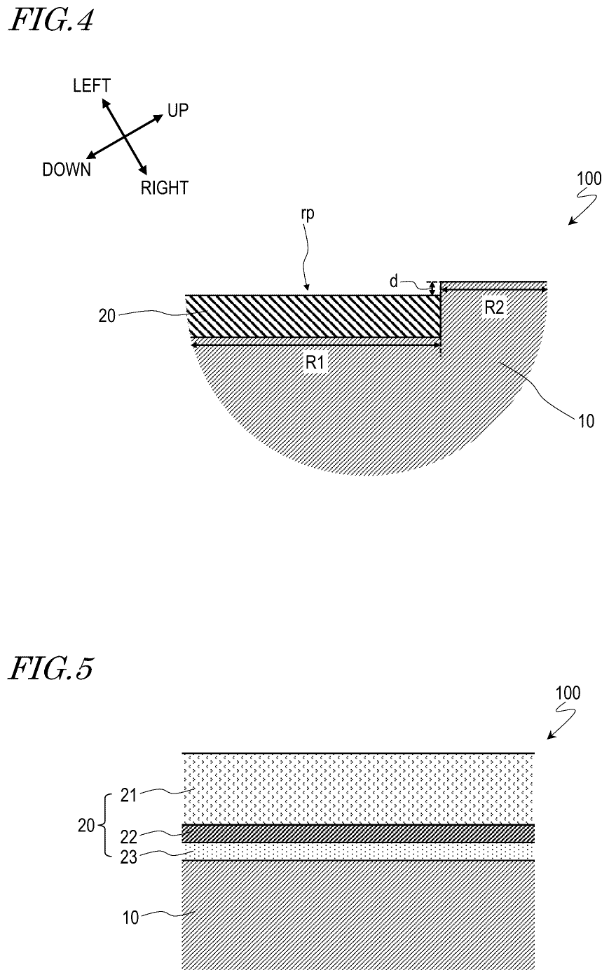

With reference to FIG. 1 through FIG. 4, an exterior cover for a straddled vehicle (hereinafter, referred to simply as an “exterior cover”) 100 according to an embodiment of the present invention will be described. FIG. 1 and FIG. 2 are respectively a front view and a rear view schematically showing the exterior cover 100. FIG. 3 is a cross-sectional view schematically showing the exterior cover 100, and shows a cross-section taken along line 3A-3A′ in FIG. 1. FIG. 4 is an enlarged view of region Re enclosed by the dotted circle in FIG. 3.

The exterior cover 100 shown in FIG. 1 through FIG. 4 is for a motorcycle. Specifically, the exterior cover 100 is a rear side cover to be located to the side of a vehicle frame, and more specifically, is a left rear side cover to be located to the left of the vehicle frame. In the following description, terms “front”, “rear”, “left”, “right”, “up” and “down” respectively refer to front, rear, left, right, up and down as seen from a rider of the motorcycle in a state where the exterior cover 100 is attached to the motorcycle.

Of a surface of the exterior cover 100, a portion visually recognizable in a state where the exterior cover 100 is attached to the motorcycle is referred to as an “exterior surface”. The exterior surface is directed leftward. As shown in FIG. 3, the exterior cover 100 includes a cover main body 101 having the exterior surface and an edge wall portion 102 extending rightward from an outer edge of the cover main body 101. As shown in FIG. 2, the edge wall portion 102 is provided in correspondence with a majority of the outer edge of the cover main body 101 in this embodiment. The ratio, of a portion of the outer edge of the cover main body 101 along which the edge wall portion 102 is provided, with respect to the entirety of the outer edge of the cover main body 101 is not limited to the ratio shown in the example of FIG. 2.

As shown in FIG. 1, FIG. 3 and FIG. 4, the exterior cover 100 includes a resin substrate layer 10 and a decorative layer 20 provided on the resin substrate layer 10.

The resin substrate layer (hereinafter, referred to as a “first substrate layer” in order to be distinguished from a substrate layer of the decorative layer 20 described below) 10 is formed of a resin material. The exterior cover 100 has an overall shape that is defined mainly by the first substrate layer 10.

The decorative layer 20 is formed on a surface of the first substrate layer 10 (main surface on the exterior surface side) and is located so as to be at the exterior surface. In the example shown here, the decorative layer 20 is provided on a region (hereinafter, referred to as a “first region”) R1, which is a part of the surface of the first substrate layer 10. In this embodiment, as shown in FIG. 4, there is a stepped portion between a surface of the decorative layer 20 and a region R2 of the surface of the first substrate layer 10 other than the first region R1 (the region other than the first region R1 will be referred to as a “second region R2”). The surface of the decorative layer 20 is lower than the second region R2. Therefore, the exterior surface of the exterior cover 100 has a recessed portion rp formed at a position corresponding to the decorative layer 20.

The decorative layer 20 may have a stack structure. FIG. 5 shows an example of the stack structure of the decorative layer 20. In the example shown in FIG. 5, the decorative layer 20 has a stack structure in which a substrate layer 21, an ink layer 22 and an adhesive layer 23 are located in this order toward the first substrate layer 10 from the exterior surface side.

The substrate layer 21 (hereinafter, referred to as a “second substrate layer 21” in order to be distinguished from the first substrate layer 10) is formed of a transparent resin material. Therefore, the ink layer 22 is visually recognizable from outside through the second substrate layer 21. The ink layer 22 has a role of providing the design of the decorative layer 20. The ink layer 22 is provided on one of two main surfaces of the second substrate layer 21 (specifically, the main surface on the first substrate layer 10 side). The adhesive layer 23 is located between the ink layer 22 and the first substrate layer 10, and has a role of bonding the stack body of the second substrate layer 21 and the ink layer 22 to the first substrate layer 10.

As described below, the exterior cover 100 including the first substrate layer 10 and the decorative layer 20 may be produced by film insert molding by use of a decorative film. The decorative film includes the second substrate layer 21, the ink layer 22 and the adhesive layer 23.

In the exterior cover 100 in this embodiment, the first substrate layer 10 includes a plurality of holes 11A, 11B, 11C, 11D, 11E, 11F and 11G. The holes 11A through 11G are each a through-hole passing through the first substrate layer 10 in a thickness direction thereof. The holes 11A through 11G are respectively defined by inner walls of cylindrical protrusions 103A, 103B, 103C, 103D, 103E, 103F and 103G protruding rightward from the cover main body 101 (see FIG. 2).

The holes 11A through 11G include first holes 11A and 11B, each of which has a relatively long diameter, and second holes 11C, 11D, 11E, 11F and 11G, each of which has a relatively short diameter.

The first holes 11A and 11B are holes to attach the exterior cover 100 to a vehicle main body (e.g., the vehicle frame). Therefore, the first holes 11A and 11B may be considered as being portions each having a structure to attach the exterior cover 100 to the vehicle main body (hereinafter, such portions will be referred to as “attachment portions”). Among the first holes 11A and 11B, the first hole 11A is located in a front portion of the exterior cover 100, and the first hole 11B is located in a rear portion of the exterior cover 100.

The second holes 11C through 11G are also holes to attach the exterior cover 100 to the vehicle main body (that is, the second holes 11C through 11G are also attachment portions). The second holes 11C through 11G are located in a bottom portion of the exterior cover 100, and are aligned in a front-rear direction.

As shown in FIG. 1, the decorative layer 20 has a shape by which areas in vicinity of the first holes 11A and 11B are cut away. That is, the decorative layer 20 includes a portion enclosing the first holes 11A and 11B partially, as seen in a plan view. Such a structure suppresses a positional shift of the decorative film during film insert molding as described below, and therefore, allows the decorative film to be located at a desired position accurately and thus may prevent the appearance from being declined.

### Method for Producing the Exterior Cover

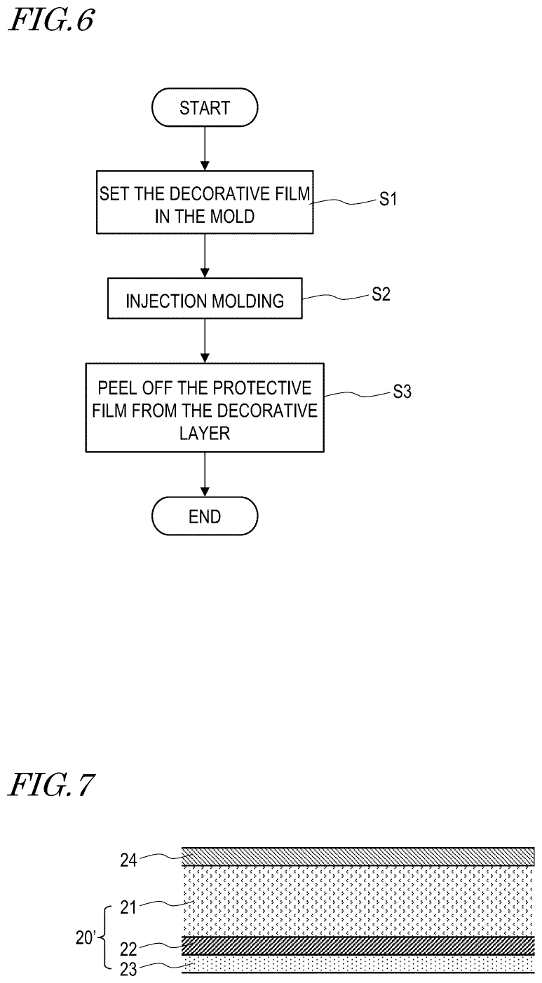

With reference to FIG. 6, a method for producing the exterior cover 100 will be described. As described above, the exterior cover 100 may be produced by film insert molding by use of a decorative film. FIG. 6 is a flowchart showing an example of the method for producing the exterior cover 100.

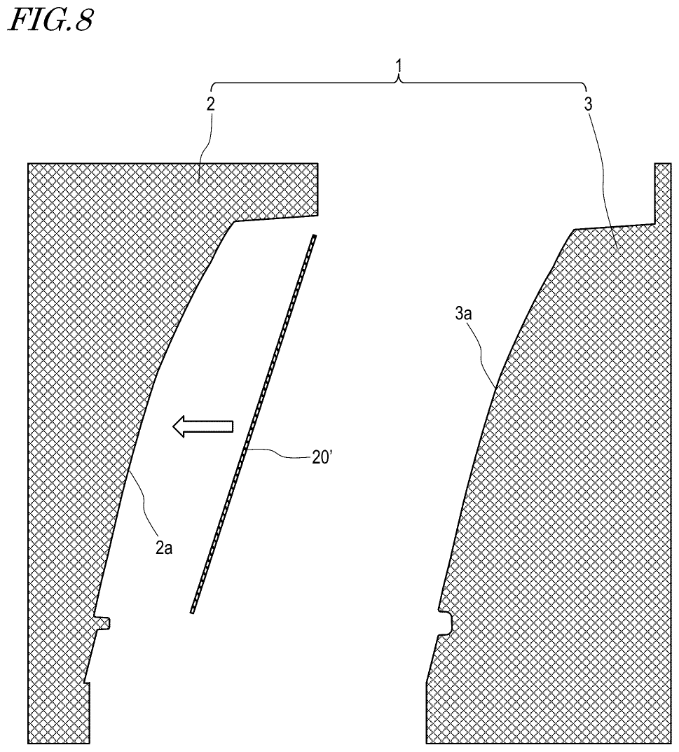

First, a decorative film is prepared, and is set in a mold (step S1). FIG. 7 shows an example of a decorative film 20′ prepared in step S1.

In the example shown in FIG. 7, the decorative film 20′ includes the second substrate layer 21, the ink layer 22 and the adhesive layer 23. To one of two main surfaces of the decorative film 20′, a protective film 24 is bonded.

The second substrate layer 21 is transparent, and acts as a support that supports the ink layer 22 and the like. The second substrate layer 21 is formed of a resin material. Any resin material is usable with no specific limitation to form the second substrate layer 21, as long as the second substrate layer 21 acts as the support. Examples of the resin material usable to form the second substrate layer 21 include polypropylene, polycarbonate, polyethylene, polyamide, polyethyleneterephthalate, acrylic resin, and the like. The second substrate layer 21 has a thickness of, for example, 40 μm or greater and 400 μm or less. The second substrate layer 21 may be of a single layer, or may have a stack structure. An example of the stack structure may be a two-layer structure of an acrylic resin layer and a polyethyleneterephthalate layer.

The ink layer 22 is provided on one of the two main surfaces of the second substrate layer 21. The ink layer 22 may provide the decorative film 20′ with decoration. The ink layer 22 may be of any of various colors. The ink layer 22 may have a metallic tone. The ink layer 22 may have a pattern. In this embodiment, the term “pattern” encompasses letters, numerals, symbols, pictorial patterns, graphical patterns, combinations thereof, and the like. The ink layer 22 may be formed by printing. The ink layer 22 may be formed of any of various known types of ink. The ink layer 22 has a thickness of, for example, 1 μm or greater and 50 μm or less.

The adhesive layer (binder layer) 23 is provided on the ink layer 22. The adhesive layer 23 may be formed of any of various known adhesives. In this specification, the term “adhesive” refers to a pressure-sensitive adhesive. The adhesive layer 23 may be formed by, for example, printing by use of a pressure-sensitive adhesive formed into ink, or may be formed by providing an adhesive on the ink layer 22 by a method other than printing. The adhesive layer 23 has a thickness of, for example, 5 μm or greater and 30 μm or less.

The decorative film 20′ has an overall thickness of, for example, 46 μm or greater and 480 μm or less.

The protective film 24 is bonded on one of the two main surfaces of the second substrate layer 21, more specifically, on one main surface not provided with the ink layer 22. The protective film 24 is bonded with, for example, a pressure-sensitive adhesive. The protective film 24 is formed of a resin material. There is no specific limitation on the resin material usable to form the protective film 24. Examples of such a resin material include polyethylene, polyethyleneterephthalate, polybutyleneterephthalate, polymethylpentene, urethane, polypropylene, and the like. The protective film 24 has a thickness of, for example, 20 μm or greater and 150 μm or less. The protective film 24 may be of a single layer, or may have a stack structure.

The decorative film 20′ is not limited to having a structure described herein as an example. The decorative film 20′ may include, for example, a metal layer instead of the ink layer 22. The metal layer is formed by, for example, vapor deposition. The metal layer may be formed of any of various known metal materials. The metal layer has a thickness of, for example, 5 nm or greater and 80 nm or less.

FIG. 8 shows how to set the decorative film 20′ in a mold 1. The mold 1 includes a fixed mold 2 and a movable mold 3. FIG. 8 shows the mold 1 in an open state. The fixed mold 2 and the movable mold 3 respectively have molding surfaces 2a and 3a. The molding surfaces 2a and 3a of the fixed mold 2 and the movable mold 3 are surfaces defining a cavity in a closed state, and are inner surfaces of the mold 1.

The decorative film 20′ is set on the molding surface 2a of the fixed mold 2 in the open state. At this point, the decorative film 20′ may be adsorbed to the molding surface 2a. The adsorption of the decorative film 20′ to the molding surface 2a may be performed by, for example, electrostatic adsorption.

According to general film insert molding, a decorative film is set in a mold after a protective film is peeled off therefrom. By contrast, in this embodiment, in step S1, the decorative film 20′ is set in the mold 1 in a state where the protective film 24 is bonded on one of the main surfaces of the decorative film 20′.

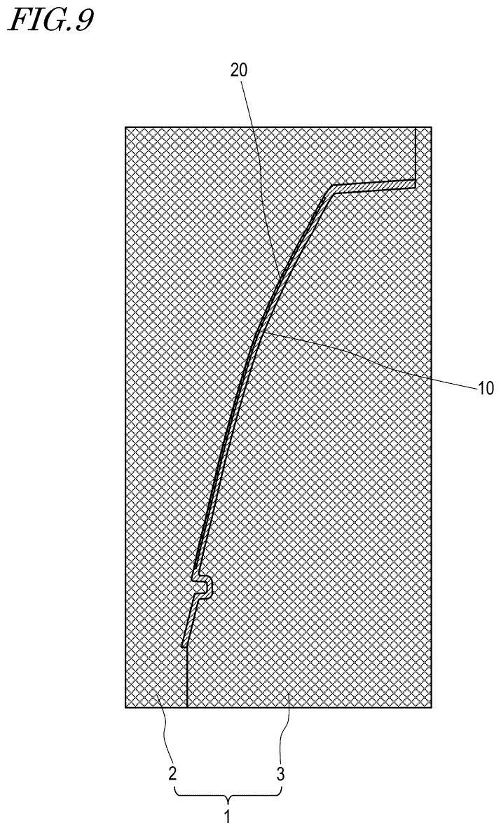

Next, the resin material is injected into the mold 1 and injection molding is performed to form a stack structure including the first substrate layer 10 and the decorative layer 20 (step S2). FIG. 9 shows a state where the above-described stack structure is formed as a result of the resin material being injected into the mold 1 (more specifically, into the cavity of the mold 1) in the closed state. The molding conditions (the temperature of the resin, the temperature of the mold, the filling pressure, injection rate, and the like) are appropriately set in accordance with the resin material to be used and the specifications (size, thickness, etc.) of the exterior cover 100. In this embodiment, there is no step, after step S1 but before step S2, of pre-forming the decorative film 20′ by vacuum forming, pressure forming or the like.

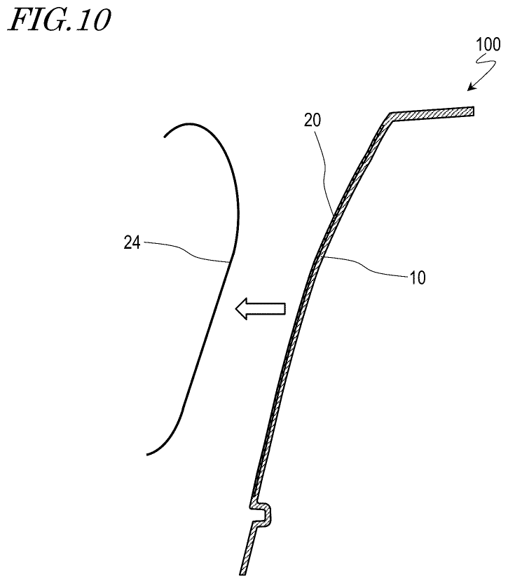

After this, the protective film 24 is peeled off from the decorative layer 20 (step S3). FIG. 10 shows how to peel off the protective film 24 from the decorative layer 20 of the exterior cover 100 taken out of the mold 1.

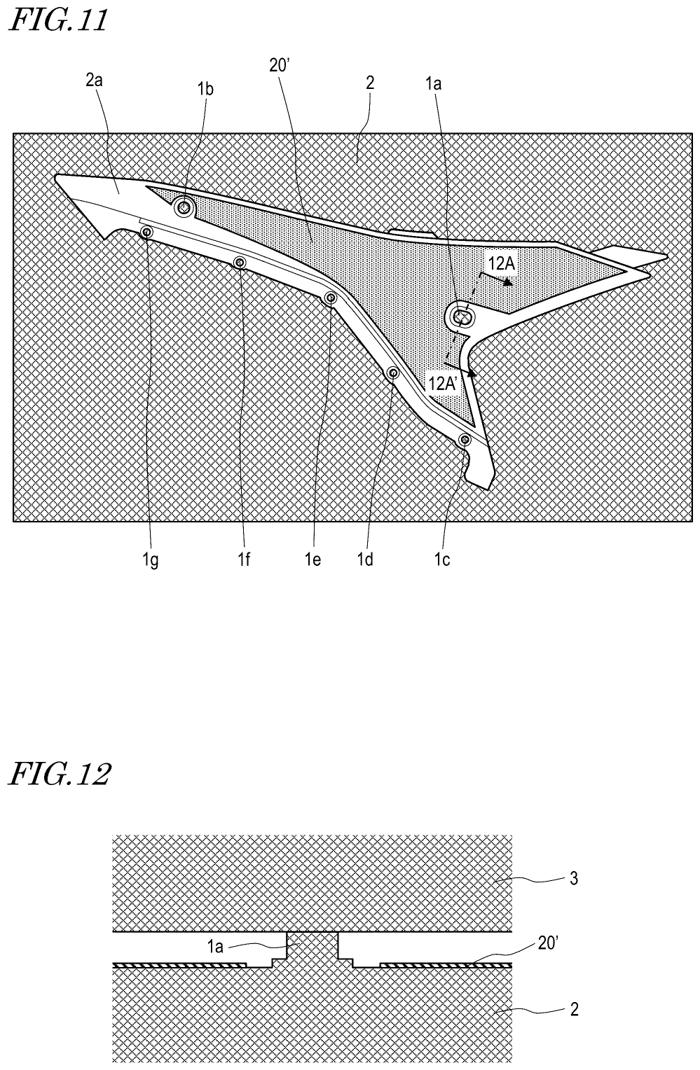

As described above, the first substrate layer 10 of the exterior cover 100 includes the attachment portions (holes 11A through 11G) each having a structure to attach the exterior cover 100 to the vehicle main body. The inner surface of the mold 1 includes protrusions to form the attachment portions of the first substrate layer 10. FIG. 11 is a plan view showing a state where the decorative film 20′ is set on the inner surface of the mold 1 (molding surface 2a of the fixed mold 2). FIG. 12 is a cross-sectional view showing a state where the mold 1 is closed after the decorative film 20′ is set, and shows a cross-section taken along line 12A-12A′ in FIG. 11.

As shown in FIG. 11 and FIG. 12, the inner surface of the mold 1 (in this embodiment, the molding surface 2a of the fixed mold 2) includes a plurality of protrusions 1a, 1b, 1c, 1d, 1e, 1f and 1g to form the attachment portions of the first substrate layer 10. The protrusions 1a through 1g respectively correspond to the holes 11A through 11G. The decorative film 20′, in a state of being set in the mold 1, has a shape partially enclosing the protrusions 1a and 1b corresponding to the first holes 11A and 11B, as seen in a plan view. When the resin material is injected into the mold 1 in step S2, there is an undesirable possibility that the decorative film 20′ moves along with a flow of the resin material. However, the decorative film 20′ is caught by the protrusions 1a and 1b of the mold 1 like being hooked when being caused to move, because the decorative film 20′ has the above-described shape. That is, it is considered that in the production method in this embodiment, step S1 is performed such that the decorative film 20′ is caught by the protrusions 1a and 1b of the mold 1 when being caused to move along with the flow of the resin material in step S2.

As described above, according to the production method of this embodiment, step S1 is performed such that the decorative film 20′ is caught by the protrusions 1a and 1b of the mold 1 when being caused to move along with the flow of the resin material in step S2. This suppresses the positional shift of the decorative film 20′ in step S2. Therefore, the decorative film 20′ is allowed to be located at a desired position accurately. This may prevent the appearance of the exterior cover 100 from being declined.

The decorative film 20′ is not limited to having a shape partially enclosing the protrusions 1a and 1b as shown in FIG. 11 as an example. As shown in FIG. 13, the decorative film 20′ may include at least one hole 20a. In the example shown in FIG. 13, the decorative film 20′ includes a plurality of (more specifically, two) holes 20a. In step S1, the decorative film 20′ is set such that the protrusions 1a and 1b are inserted into the holes 20a. In step S2, inner circumferential surfaces of the holes 20a are caught by the protrusions 1a and 1b, so that the positional shift of the decorative film 20′ is suppressed.

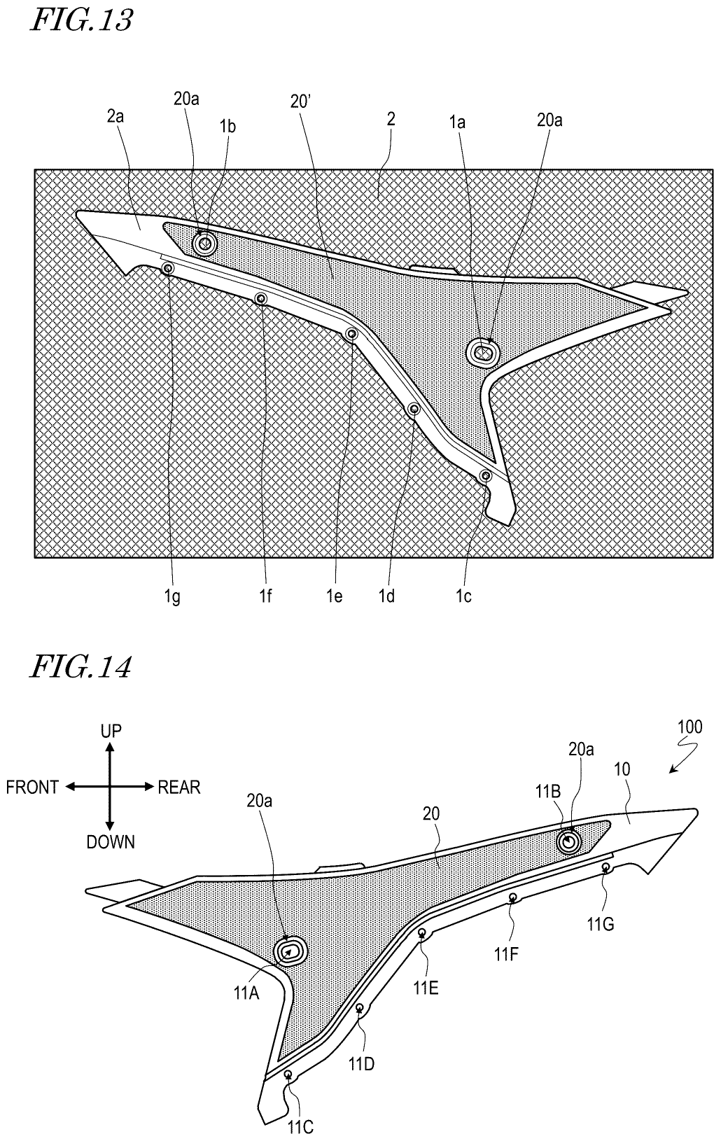

FIG. 14 shows the exterior cover 100 produced by use of the decorative film 20′ shown in FIG. 13. In the exterior cover 100 shown in FIG. 14, the holes 20a of the decorative film 20′ are present as the holes 20a of the decorative layer 20 as they are. The decorative layer 20 includes a portion enclosing the entirety of the first holes 11A and 11B of the first substrate layer 10 as seen in a plan view.

As can be seen, it is sufficient that the decorative film 20′, in a state of being set in the mold 1, has a shape enclosing the protrusions at least partially (that is, partially or entirely) as seen in a plan view. In the case where the decorative film 20′ has a shape partially enclosing the protrusions, it is preferred that at least 50% of the entire circumference of each of the protrusions by which the decorative film 20′ is caught is enclosed by the decorative film 20′, from the point of view of suppressing the positional shift of the decorative film 20′.

In the above description, the decorative film 20′ is caught by the two protrusions 1a and 1b. The decorative film 20′ is not limited to being caught by two protrusions, and may be caught by one protrusion or three or more protrusions. In the case where the inner surface of the mold 1 includes a plurality of protrusions, it is preferred that step S1 is performed such that the decorative film 20′ is caught by two or more protrusions when being caused to move in step S2. The decorative film 20′ is caught by two or more protrusions, so that a rotation of the decorative film 20′ is suppressed. Therefore, the positional shift of the decorative film 20′ is suppressed more certainly. In other words, in the case where the first substrate layer 10 has a plurality of holes, it is preferred that the decorative layer 20 includes a portion enclosing two or more holes at least partially as seen in a plan view.

According to the production method in this embodiment, in step S1, the decorative film 20′ having the protective film 24 bonded to one of the two main surfaces thereof is set in a space of the mold 1, and in step S3 performed after step S2, the protective film 24 is peeled off from the decorative layer 20. This provides the following advantages.

In the case where there are foreign objects such as dust or the like between the inner surface of the mold and the decorative film, it may be possible that the foreign objects are attached to the decorative layer of the resultant exterior cover and are not removed therefrom, or that the decorative layer is deformed (damaged) by the foreign objects. In such a case, the appearance of the exterior cover may be undesirably declined. Therefore, in order to prevent the appearance of the exterior cover from being declined due to the foreign objects, a work of removing the foreign objects is performed before the step of setting the decorative film in the mold, for example.

In this embodiment, in step S1, the decorative film 20′ having the protective film 24 bonded thereto is set in the mold 1, and in step S3, the protective film 24 is peeled off from the decorative layer 20. With such an arrangement, even if there are foreign objects between the inner surface of the mold 1 and the protective film 24, the foreign objects are prevented from being attached to the decorative layer 20 because the foreign objects are peeled off, together with the protective film 24, from the decorative layer 20. In addition, the protective film 24 acts as a cushion, and therefore, the deformation (damage) of the decorative layer 20 is prevented. This may make it unnecessary to perform the work of removing the foreign objects.

When the protective film 24 is peeled off from the decorative layer 20, as shown in FIG. 4, a stepped portion corresponding to the thickness of the protective layer 24 is formed between the region, of the surface of the exterior cover 100, where the decorative layer 20 is present (first region R1), and the region, of the surface of the exterior cover 100, where the decorative layer 20 is not present (second region R2). In the case where the exterior cover 100 is to be in contact with the body of a rider, this stepped portion may improve the slip resistance.

Depth d of the stepped portion, that is, the depth d of the recessed portion rp (in other words, the thickness of the protective film 24) is appropriately set in accordance with the degree of slip resistance desired. From the point of view of improving the slip resistance, the depth d of the recessed portion rp is preferably 20 μm or greater, and more preferably, 40 μm or greater.

In the case where the decorative film 20′ having the protective film 24 bonded thereto is set in step S1, it is preferred that the step of pre-forming the decorative film 20′ is not performed after step S1 but before step S2. If the step of pre-forming the decorative film 20′ is performed, the pressure-sensitive adhesive is hardened by the heat of the pre-forming, which may undesirably make it difficult to peel off the protective film 24. By contrast, in the case where the step of pre-forming the decorative film 20′ is not performed, a situation is prevented where the pressure-sensitive adhesive is hardened and thus it is made difficult to peel off the protective film 24.

The protective film 24 may include a plurality of regions having different thicknesses from each other. FIG. 15 shows such of the protective film 24. The protective film 24 shown in FIG. 15 includes a high stack region RA and a low stack region RB.

The high stack region RA includes a first layer 24a and a second layer 24b provided on the first layer 24a. By contrast, the low stack region RB includes only the first layer 24a. Therefore, thickness t2 of the first layer 24a is less than thickness t1 of the high stack region RA.

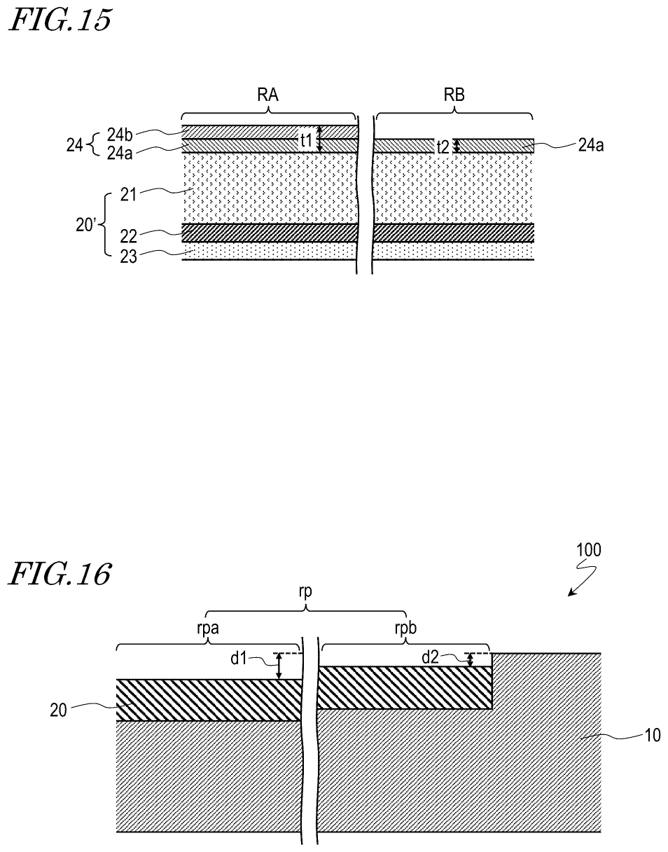

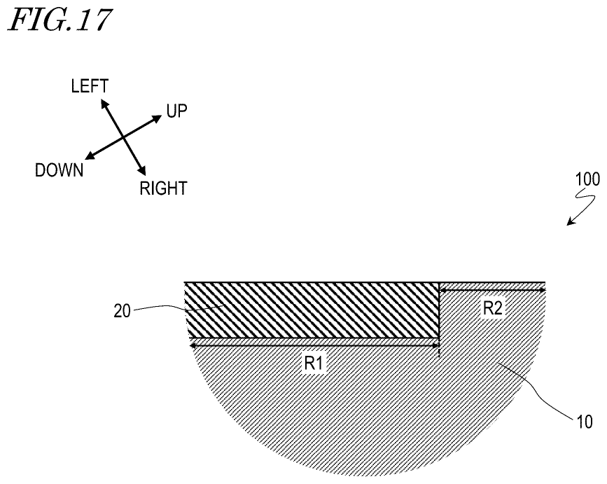

In the case where the protective film 24 includes such a plurality of regions having different thicknesses from each other, the surface of the exterior cover 100 is allowed to include a plurality of regions having different depths of the stepped portion (depths of the recessed portion rp). Therefore, the slip resistance of the exterior cover 100 is adjustable on a region-by-region basis. FIG. 16 shows such an example of the exterior cover 100. In the example shown in FIG. 16, a region rpa, of the recessed portion rp, which is formed in correspondence with the high stack region RA of the protective film 24, and a region rpb, of the recessed portion rp, which is formed in correspondence with the low stack region RB of the protective film 24, have different depths from each other. Specifically, depth d1 of the former region rpa is greater than depth d2 of the latter region rpb.

The number of the layer(s) of each of the high stack region RA and the low stack region RB of the protective film 24 is not limited to the number shown in FIG. 15 (two layers and one layer, respectively). The structure of the protective film 24 including a plurality of regions having different thicknesses from each other is not limited to the structure, as described above, in which the number of layer(s) varies on a region-by-region basis.

In step S1, the decorative film 20′ having the protective film 24 peeled off therefrom may be set in the mold 1. In this case, as shown in FIG. 17, the resultant exterior cover 100 has no stepped portion between the second region R2 of the surface of the first substrate layer 10 and the surface of the decorative layer 20.

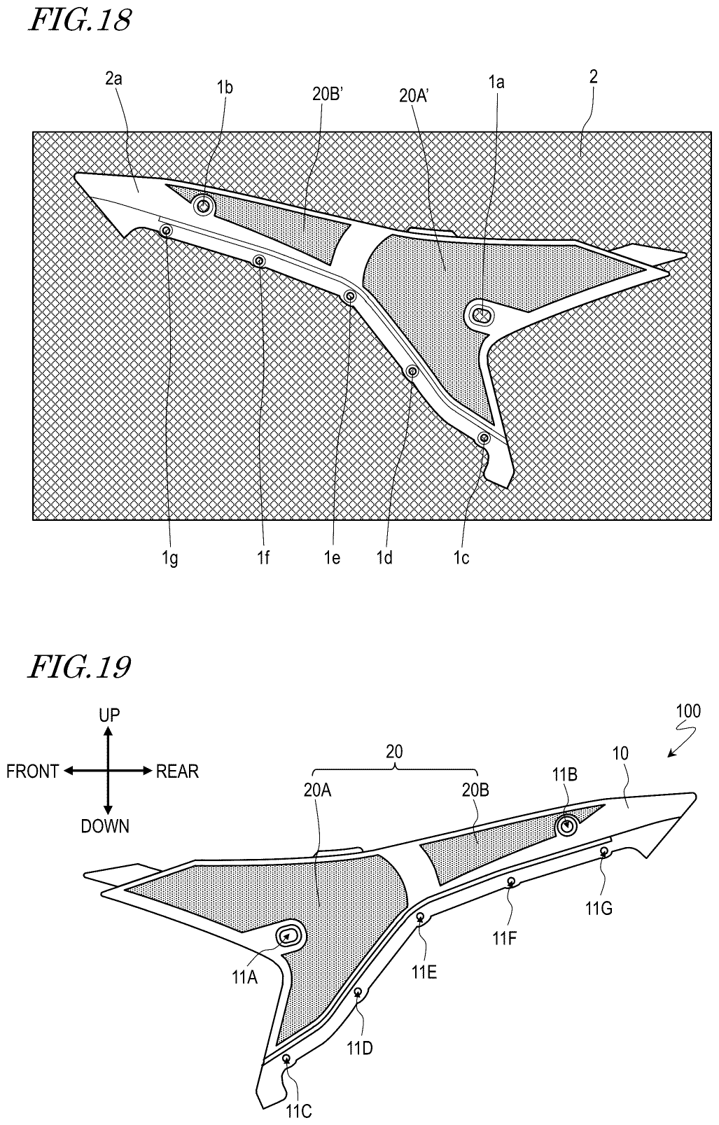

In step S1, a plurality of the decorative films 20′ may be prepared and may be set in the mold 1 separately from each other. FIG. 18 shows an example of such a form. In the example shown in FIG. 18, in step S1, two decorative films 20A′ and 20B′ are prepared and are set in the mold 1 separately from each other. This may realize a structure in which the decorative layer 20 includes a plurality of portions 20A and 20B separated from each other, as shown in FIG. 19.

### Straddled Vehicle

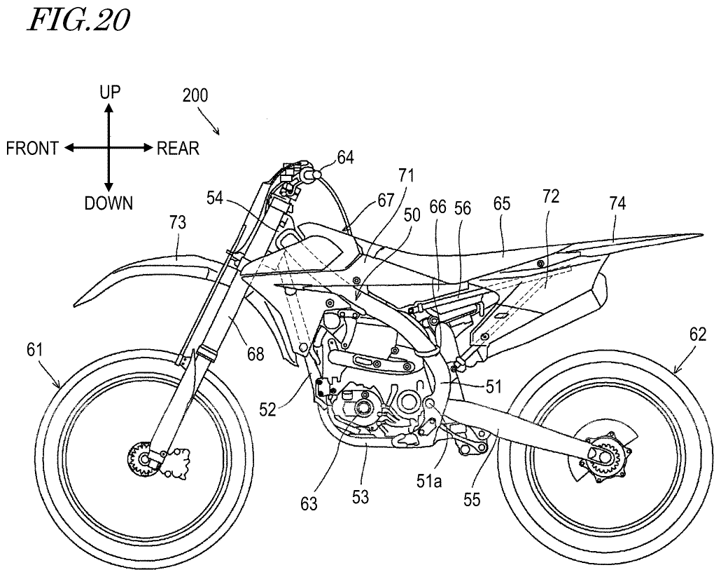

FIG. 20 shows an example of straddled vehicle including the exterior cover according to an embodiment of the present invention. FIG. 20 shows an off-road motorcycle 200 called a “motocrosser” as an example of the straddled vehicle. It should be noted that the straddled vehicle is not limited to the off-road motorcycle 200. A straddled vehicle is a vehicle that a rider rides in a straddling manner. The straddled vehicle may be a motorcycle of any other type such as on-road motorcycle, a scooter, a moped or the like, or may be a vehicle other than a motorcycle such as a tricycle, an all terrain vehicle (ATV), a jet ski bike, a snowmobile or the like.

As shown in FIG. 20, the motorcycle 200 includes a vehicle frame 50, a front wheel 61 and a rear wheel 62. The vehicle frame 50 supports an engine 63, a handle 64, a seat 65 and a fuel tank 66 directly or indirectly.

The vehicle frame 50 includes a pair of main frames 51, a down frame 52, a pair of bottom frames 53, a head pipe 54, a pair of rear arms 55, and a seat rail 56. The head pipe 54 is located in a front portion of the motorcycle 200. The main frames 51 extend downward and rearward obliquely from the head pipe 54. The down frame 52 is located below the main frames 51, and extends downward and rearward obliquely from the head pipe 54. The bottom frames 53 connect a bottom end of the down frame 52 and bottom ends of the main frames 51 to each other. The seat rail 56 extends rearward from the main frames 51.

The engine 63 is located below the main frames 51 and to the rear of the down frame 52. An air cleaner 67 is located to the rear of the head pipe 54. The seat 65 supported by the seat rail 56 is located to the rear of the air cleaner 67 and above the main frames 51. The fuel tank 66 is located below a front portion of the seat 65.

A steering shaft (not shown) is inserted into the head pipe 54, and the handle 64 is connected to a top portion of the steering shaft. A pair of front forks 68 are located side by side with the steering shaft. The front wheel 61 is rotatably attached to bottom ends of the front forks 68.

A pivot shaft 51a is provided at rear portions of the main frames 51. Front end portions of the rear arms 55 are supported by the pivot shaft 51a. The rear arms 55 are swingable up and down with respect to the main frames 51 by the pivot shaft 51a. The rear wheel 62 is rotatably attached to rear end portions of the rear arms 55.

Various exterior covers each covering a part of the vehicle frame 50 are supported by the vehicle frame 50. The motorcycle 200 shown here as an example includes a pair of front side covers 71, a pair of rear side covers 72, a front fender 73 and a rear fender 74 as the exterior covers.

The front side covers 71 are located below the front portion of the seat 65, and are supported by top portions of the main frames 51 and a top portion of the down frame 52. The rear side covers 72 are located below a rear portion of the seat 65, and are supported by the seat rail 56.

The front fender 73 is located above the front wheel 61, and is supported by the front fork 68. The rear fender 74 is located above the rear wheel 62, and is supported by the seat rail 56.

The exterior cover according to an embodiment of the present invention may be any of the front side covers 71, the rear side covers 72, the front fender 73 and the rear fender 74 described above. FIG. 20 omits the decorative layer 20.

As described above, the method for producing the exterior cover 100 for a straddled vehicle according to an embodiment of the present invention is for producing the exterior cover 100 for a straddled vehicle, the exterior cover 100 including the resin substrate layer 10 and the decorative layer 20 provided on the resin substrate layer 10. The method includes step (a) of preparing the decorative film 20′ and setting the decorative film 20′ in the mold 1; and step (b) of, after step (a), injecting a resin material into the mold 1 and performing injection molding to form a stack structure including the resin substrate layer 10 and the decorative layer 20. The resin substrate layer 10 includes the attachment portion 11A having a structure to attach the exterior cover 100 to the vehicle main body. The inner surface of the mold 1 includes the protrusion 1a to form the attachment portion 11A of the resin substrate layer 10. Step (a) is performed such that the decorative film 20′ is caught by the protrusion 1a of the mold 1 when being caused to move along with a flow of the resin material in step (b).

The method for producing the exterior cover 100 for a straddled vehicle according to an embodiment of the present invention includes step (a) of preparing the decorative film 20′ and setting the decorative film 20′ in the mold 1; and step (b) of, after step (a), injecting a resin material into the mold 1 and performing injection molding to form a stack structure including the resin substrate layer 10 and the decorative layer 20. In the production method according to an embodiment of the present invention, the inner surface of the mold 1 includes the protrusion 1a to form the attachment portion 11A of the resin substrate layer 10. Step (a) is performed such that the decorative film 20′ is caught by the protrusion 1a of the mold 1 when being caused to move along with a flow of the resin material in step (b). Therefore, the positional shift of the decorative film 20′ in step (b) is suppressed. This allows the decorative film 20′ to be located at a desired position accurately and thus may prevent the appearance of the exterior cover 100 from being declined.

In an embodiment, the decorative film 20′ has a shape partially enclosing the protrusion 1a as seen in a plan view in a state of being set in the mold 1.

In the case where the decorative film 20′ has a shape partially enclosing the protrusion 1a as seen in a plan view in a state of being set in the mold 1, the decorative film 20′ may be caught by the protrusion 1a like being hooked, and this suppresses the positional shift of the decorative film 20′.

In an embodiment, the decorative film 20′ includes the hole 20a, and in step (a), the decorative film 20′ is set such that the protrusion 1a is inserted into the hole 20a.

In the case where the decorative film 20′ includes the hole 20a and the decorative film 20′ is set such that the protrusion 1a is inserted into the hole 20a, the inner circumferential surface of the hole 20a is caught by the protrusion 1a, so that the positional shift of the decorative film 20′ is suppressed.

In an embodiment, the inner surface of the mold 1 includes a plurality of the protrusions, and step (a) is performed such that the decorative film 20′ is caught by at least two of the plurality of protrusions when being caused to move in step (b).

In the case where the inner surface of the mold 1 includes the plurality of protrusions, it is preferred that step (a) is performed such that the decorative film 20′ is caught by at least two of the protrusions when being caused to move in step (b). The decorative film 20′ is caught by at least two of the protrusions, so that a rotation of the decorative film 20′ is suppressed. Therefore, the positional shift of the decorative film 20′ is suppressed more certainly.

In an embodiment, in step (a), the decorative film 20′ is set in the mold 1 in a state where the decorative film 20′ has the protective film 24 bonded to one of the main surfaces thereof, and the production method further includes step (c) of, after step (b), peeling off the protective film 24 from the decorative layer 20.

In step (a), the decorative film 20′ may be set in the mold 1 in a state where the decorative film 20′ has the protective film 24 bonded to one of the main surfaces thereof. In this case, in step (c) performed after step (b), the protective film 24 is peeled off from the decorative layer 20.

In the case where there are foreign objects such as dust or the like between the inner surface of the mold 1 and the decorative film 20′, it may be possible that the foreign objects are attached to the decorative layer 20 of the resultant exterior cover 100 and are not removed therefrom, or that the decorative layer 20 is deformed (damaged) by the foreign objects. In such a case, the appearance of the exterior cover 100 may be undesirably declined. Therefore, in order to prevent the appearance of the exterior cover 100 from being declined due to the foreign objects, a work of removing the foreign objects is performed before step (a), for example.

In step (a), the decorative film 20′ is set in the mold 1 in a state where the decorative film 20′ has the protective film 24 bonded to one of the main surfaces thereof, and then, in step (c), the protective film 24 is peeled off from the decorative layer 20. With such an arrangement, even if there are foreign objects between the inner surface of the mold 1 and the protective film 24, the foreign objects are prevented from being attached to the decorative layer 20 because the foreign objects are peeled off, together with the protective film 24, from the decorative layer 20. In addition, the protective film 24 acts as a cushion, and therefore, the decorative layer 20 is prevented from being deformed (damaged) by the foreign objects. This may make it unnecessary to perform the work of removing the foreign objects.

When the protective film 24 is peeled off from the decorative layer 20, a stepped portion corresponding to the thickness of the protective layer 24 is formed between the region, of the surface of the exterior cover 100, where the decorative layer 20 is present, and the region, of the surface of the exterior cover 100, where the decorative layer 20 is not present. In the case where the exterior cover 100 is to be in contact with the body of a rider, this stepped portion may improve the slip resistance.

In an embodiment, the production method does not include the step of pre-forming the decorative film 20′ after step (a) but before step (b).

In the case where the decorative film 20′ having the protective film 24 bonded thereto is set in step (a), it is preferred that the step of pre-forming the decorative film 20′ is not performed after step (a) but before step (b). The step of pre-forming the decorative film 20′ is not performed, so that a situation is prevented where the pressure-sensitive adhesive is hardened and thus it is made difficult to peel off the protective film 24.

In an embodiment, the protective film 24 includes the plurality of regions RA and RB having different thicknesses from each other.

In the case where the protective film 24 includes the plurality of regions RA and RB having different thicknesses from each other, the surface of the exterior cover 100 is allowed to include a plurality of regions having different depths of the stepped portion. Therefore, the slip resistance of the exterior cover 100 is adjustable on a region-by-region basis.

In an embodiment, in step (a), a plurality of the decorative films 20′ are prepared, and the plurality of decorative films 20A′ and 20B′ are set in the mold 1 separately from each other.

In step (a), a plurality of the decorative films 20′ may be prepared, and the plurality of decorative films 20A′ and 20B′ may be set in the mold 1 separately from each other. This may realize a structure in which the decorative layer 20 includes the plurality of portions 20A and 20B separated from each other.

The exterior cover 100 for a straddled vehicle according to an embodiment of the present invention includes the resin substrate layer 10, and the decorative layer 20 provided on the resin substrate layer 10. The resin substrate layer 10 includes the hole 11A, and the decorative layer 20 has a shape enclosing the hole 11A at least partially as seen in a plan view.

The exterior cover 100 for a straddled vehicle according to an embodiment of the present invention includes the resin substrate layer 10 and the decorative layer 20 provided on the resin substrate layer 10, and may be produced by film insert molding by use of the decorative film 20′. In the exterior cover 100 for a straddled vehicle according to an embodiment of the present invention, the resin substrate layer 10 includes the hole 11A, and the decorative layer 20 has a shape enclosing the hole 11A at least partially as seen in a plan view. Such a structure suppresses the positional shift of the decorative film 20′ during the film insert molding. This allows the decorative film to be located at a desired position accurately and thus may prevent the appearance from being declined.

In an embodiment, the decorative layer 20 includes a portion partially enclosing the hole 11A as seen in a plan view.

The decorative layer 20 may include a portion partially enclosing the hole 11A of the resin substrate layer 10 as seen in a plan view.

In an embodiment, the decorative layer 20 includes a portion enclosing the entirety of the hole 11A as seen in a plan view.

The decorative layer 20 may include a portion enclosing the entirety of the hole 11A of the resin substrate layer 10 as seen in a plan view.

In an embodiment, the resin substrate layer 10 includes a plurality of the holes, and the decorative layer 20 includes a portion enclosing at least two holes among the plurality of holes at least partially as seen in a plan view.

In the case where the resin substrate layer 10 includes the plurality of holes, it is preferred that the decorative layer 20 includes a portion enclosing at least two of the holes at least partially as seen in a plan view. This suppresses a rotation of the decorative film 20′ during the film insert molding, and therefore, suppresses the positional shift of the decorative film 20′ more certainly.

In an embodiment, the decorative layer 20 is provided on the first region R1, which is a part of the main surface of the resin substrate layer 10. There is a stepped portion between the surface of the decorative layer 20 and the second region R2, which is a region of the main surface of the resin substrate layer 10 other than the first region R1, and the surface of the decorative layer 20 is lower than the second region R2.

With the structure in which there is a stepped portion between the surface of the decorative layer 20 and the region (second region R2) of the main surface of the resin substrate layer 10 other than the region (first region R1) where the decorative layer 20 is provided, in the case where the exterior cover 100 is to be in contact with the body of a rider, this stepped portion may improve the slip resistance.

In an embodiment, the exterior cover 100 includes a plurality of regions having different depths of the stepped portion.

In the case where the exterior cover 100 includes the plurality of regions having different depths of the stepped portion, the slip resistance of the exterior cover 100 is adjustable on a region-by-region basis.

In an embodiment, the decorative layer 20 includes the plurality of portions 20A and 20B separated from each other.

The decorative layer 20 may include the plurality of portions 20A and 20B separated from each other.

A straddled vehicle according to an embodiment of the present invention includes the exterior cover 100 for a straddled vehicle having any of the above-described structures.

An embodiment of the present invention provides an exterior cover for a straddled vehicle and a method for producing the same by which the positional shift of the decorative film during film insertion molding is suppressed. The production method according to an embodiment of the present invention is preferably usable to produce exterior covers for various types of straddled vehicles including motorcycles.

This application is based on Japanese Patent Application No. 2023-107267 filed on Jun. 29, 2023, the entire contents of which are hereby incorporated by reference.

What is claimed is:

1. A method for producing an exterior cover for a straddled vehicle, the exterior cover including a resin substrate layer and a decorative layer provided on the resin substrate layer, the method comprising:
providing a mold having a protrusion on an inner surface thereof;
preparing a decorative film and setting the decorative film in the mold; and
subsequently injecting a resin material into the mold and performing injection molding, to thereby form a stack structure including the resin substrate layer and the decorative layer, wherein
said providing the mold including forming the protrusion in such a shape that, in said step of injecting the resin material into the mold and performing the injection molding,
the protrusion causes an attachment portion to be formed on the resin substrate layer, the attachment portion being so shaped as to allow the exterior cover to be attachable to a main body of the straddled vehicle, and
the protrusion catches the decorative film when the decorative film moves along with a flow of the resin material.

2. The method of claim 1, wherein the decorative film is so set in the mold as to have a shape partially enclosing the protrusion in a plan view thereof.

3. The method of claim 1,
wherein the decorative film has a hole therein, and
wherein said setting the decorative film includes inserting the protrusion into the hole.

4. The method of claim 1,
wherein said providing the mold includes providing the mold having a plurality of protrusions, including said protrusion, on the inner surface thereof, and
wherein the plurality of protrusions are configured to catch the decorative film by at least two of the plurality of protrusions when the decorative film moves along the flow of the resin material.

5. The method of claim 1,
wherein said preparing the decorative film includes preparing the decorative film to have a protective film bonded to one of main surfaces thereof, and
wherein the method for producing the exterior cover further includes, after performing the injection molding, peeling off the protective film from the decorative layer.

6. The method of claim 5, wherein the method does not include pre-forming the decorative film after said setting the decorative film in the mold and before said injecting the resin material into the mold.

7. The method of claim 5, wherein the protective film includes a plurality of regions having different thicknesses from one another.

8. The method of claim 1, wherein
said preparing the decorative film includes preparing a plurality of decorative films including said decorative film, and
the plurality of decorative films are set in the mold separately from one another.

9. An exterior cover for a straddled vehicle, comprising:
a substrate layer formed of resin; and
a decorative layer provided on the substrate layer,
wherein the substrate layer has a hole formed therein, and
wherein the decorative layer is so shaped as to enclose the hole at least partially in a plan view of the exterior cover.

10. The exterior cover for a straddled vehicle of claim 9, wherein the decorative layer includes a portion partially enclosing the hole in the plan view.

11. The exterior cover for a straddled vehicle of claim 9, wherein the decorative layer includes a portion enclosing an entirety of the hole in the plan view.

12. The exterior cover for a straddled vehicle of claim 9,
wherein the substrate layer has a plurality of holes, including said hole, formed therein, and
wherein the decorative layer includes a portion enclosing at least two holes among the plurality of holes at least partially in the plan view.

13. The exterior cover for a straddled vehicle of claim 9,
wherein the substrate layer has a main surface, which includes a first region and a second region that are different from each other,
wherein the decorative layer is provided in the first region, and
wherein a surface of the decorative layer forms a stepped portion with the second region, with the surface of the decorative layer positioned lower than the second region.

14. The exterior cover for a straddled vehicle of claim 13, wherein
the main surface of the substrate layer has a plurality of regions including the first region and the second region, to thereby form a plurality of stepped portions, including said stepped portion, that have different depths.

15. The exterior cover for a straddled vehicle of claim 9, wherein the decorative layer includes a plurality of portions separated from one another.

16. A straddled vehicle, comprising the exterior cover of claim 9.
